(19) United States
(12) Patent Application Publication
(10) Pub. No.: US 2006/0259945 A1
(43) Pub. Date: Nov. 16, 2006

(54) Television broadcast receiver, television broadcast receiving method and television system

(76) Inventors: Takahiro Kimura, Fukaya-shi (JP); Akira Miyazawa, Saitama-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/407,946

(22) Filed: Apr. 21, 2006

(30) Foreign Application Priority Data
Apr. 22, 2005 (JP) 2005-125493

(51) Int. Cl. H04N 7/16; G06F 3/00; G06F 13/00; H04N 5/44; H04N 7/173; H04N 5/445

(52) U.S. Cl. 725/151; 725/100; 725/131; 725/108; 348/725; 725/139; 725/39; 725/52; 725/53

(57) ABSTRACT

A television broadcast receiver can operate external recording equipment with the same feel as that of internal recording equipment so as not to extremely corrupt recorded information even when the internal recording equipment is not expected to be used because of a failure or any inconvenience thereof. Therefore, the receiver has a control unit to manage operations, a receiving unit to receive a broadcast signal, a demodulating and signal processing unit to demodulate and signal process the received signal to convert it into a display signal, and a recording unit. And the receiver further comprises a housing unit to house internal recording equipment integrated with the receiver, a connection terminal to connect external recording equipment, and a using equipment switching unit to switch for controlling the external recording equipment as the internal recording equipment in response to operations.

### CROSS-REFERENCE TO RELATED APPLICATIONS

This application is based upon and claims the benefit of priority from Japanese Patent Application No. 2005-125493, filed Apr. 22, 2005, the entire contents of which are incorporated herein by reference.

### BACKGROUND

1. Field

Embodiments of the present invention relate to a television broadcast receiver, a television broadcast receiving method and a television system. More specifically, one embodiment of the invention relates to improvement in a switching function of recording equipment to be used.

2. Description of the Related Art

In recent years, an information recording medium such as a hard disk and an optical disk as a recording medium has been increased in storage capacity. Therefore, a method and an apparatus for automatically recording a desired program on an information recording medium by connecting recording/reproducing equipment using the information recording medium to, for example, a television receiver have been available.

In general, program recording reservation information is prepared by using electronic program guide (EPG) information so as to realize an automatic recording function and an automatic recording/reproducing apparatus. It has been taken into consideration for an apparatus to automatically set the recording reservation information by automatically searching for a program corresponding to a category from the EPG information when a desired category is specified. Such an apparatus is configured to receive a broadcast program to record it in an internal hard disk driver (HDD), based on the recording reservation information. Such a technique is disclosed by patent documents of patent applications: Jpn. Pat. Appln. KOKAI Publication No. 2003-272297 and Jpn. Pat. Appln. KOKAI Publication No. 2004-186958.

An apparatus for recording on an internal memory and transmitting recorded information stored in the memory in a prescribed transmission form to record it on an external recording medium has been developed. When reproducing the information stored on the external recording medium, the apparatus moves the recorded information once from the external recording medium to the internal memory to reproduce it by a broadcast receiver.

However, the above-mentioned conventional apparatus is premised on a normal operation of internal recording equipment. Therefore, the conventional apparatus becomes impossible to entirely control and operate when the internal recording equipment fails.

### BRIEF SUMMARY OF THE INVENTION

An embodiment of the present invention provides a television broadcast receiver, a television broadcast receiving method and a television system for operating external recording equipment with the same feel as that of internal recording equipment even if the internal recording equipment is not expected to be used because of a failure or any inconvenience thereof and preventing recorded information from being extremely spoiled.

The broadcast receiver comprises a control unit to manage operations; a receiving unit to receive a broadcast signal; a demodulating and signal processing unit to demodulate and signal process the received signal to covert it into a display signal; and a recording processing unit to record the display signal in a recording medium. The broadcast receiver has a housing unit for a first recording equipment connected to the broadcast receiver as main recording equipment; a connection terminal for connecting second recording equipment outside the broadcast receiver; and a using equipment switching unit to switch the control unit so that the second recording equipment is operated in response to an operation instruction after setting the second recording equipment.

Thereby, the broadcast receiver can operate the external second recording equipment with the same feel as that of the internal recording equipment even if the internal first recording equipment has failed and improve the reliability of the television system without corrupting the recording information.

Additional objects and advantages of the embodiments will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary view for explaining an outline of a digital television broadcast receiver to which the present invention is adopted;

FIG. 2 is an exemplary view showing an external view of the broadcast receiver in FIG. 1;

FIG. 3 is an exemplary view for further specifically showing a configuration of an inside of the broadcast receiver in FIG. 1;

FIG. 4 is an exemplary view for explaining an external view of a remote controller used in the broadcast receiver of the present invention;

FIG. 5 is an exemplary flowchart when the broadcast receiver in FIG. 1 records a program on the basis of EPG information;

FIG. 6 is an exemplary view when the broadcast receiver in FIG. 1 displays program information on a video display;

FIG. 7 is an exemplary flowchart of the operations in the case that the program is reproduced from digital recording equipment by the broadcast receiver in the embodiment in FIG. 1;

FIG. 8 is an exemplary embodiment of a navigation menu displayed in reproduction operations of the receiver in the embodiment in FIG. 1;

FIG. 9 is an exemplary view for explaining a selected state in which an item of a recorded program from a navigation menu regarding the embodiment of the present invention;

FIG. 10 is an exemplary view for explaining a list display screen of recently video recorded programs obtained from navigation menu in the embodiment of the present invention;

FIG. 11 is an exemplary view showing a configuration of a characteristic part in the embodiment of the present invention;

FIG. 12 is an exemplary flowchart for explaining an example of operations of a characteristic part in the embodiment of the present invention;

FIG. 13 is an exemplary view showing a screen with added equipment just registered thereon in the embodiment of the present invention;

FIG. 14 is an example view showing a screen with added equipment just registered thereon in the embodiment of the present invention; and

FIG. 15 is an example view showing a screen showing an aspect of utilizing of added equipment in the embodiment of the present invention.

### DETAILED DESCRIPTION

Hereinafter, embodiments of the present invention will be explained by referring to the drawings. At first, we will explain an outline of a broadcast receiver with the present invention adopted thereto.

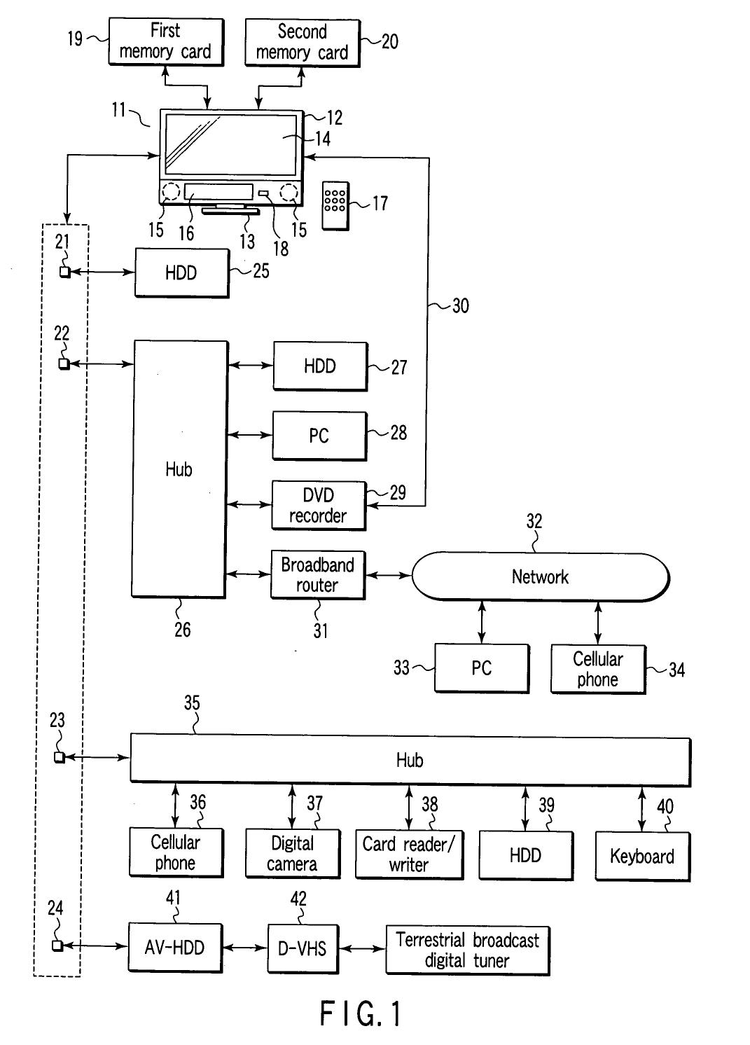

FIG. 1 schematically shows an embodiment of the external appearance of a digital television broadcast receiver 11 described in this embodiment and a network system configured around the broadcast receiver 11.

The broadcast receiver 11 is composed mainly of a thin cabinet 12 and a support base 13 making the cabinet 12 raised and supported. The cabinet 12 is provided with a flat panel type video display unit 14 composed of a liquid crystal display panel or the like, a loudspeaker 15, an operation unit 16, and a light receiving unit 18 to receive operation information transmitted from a remote controller 17.

The broadcast receiver 11 is adapted to receive a first detachable memory card 19 such as a secure digital (SD) memory card, a multimedia card (MMC) or a memory stick, and performs recording/reproducing of information about such as a program or a photograph to and from the first memory.

The broadcast receiver 11 is further adapted to receive a second detachable memory card (IC card) 20 with, for example, contract information recorded thereon and performs recording/reproducing of information to and from the second memory card 20.

The broadcast receiver 11 is provided with a first local area network (LAN) terminal 21, a second LAN terminal 22, a universal serial bus (USB) terminal 23 and an i.Link terminal 24.

Among these parts, the first LAN terminal 21 is used as a LAN-compatible HDD dedicated port. The first LAN terminal 21 is connected to a LAN-compatible HDD 25 being network attached storage (NAS). The first LAN terminal 21 is used to record/reproduce information to and from through a network (e.g., an Ethernet network).

As mentioned above, by providing the first LAN terminal 21 to be the LAN-compatible HDD dedicated port, the broadcast receiver 11 can record a program with a high image quality to the HDD 25 without being influenced by other network environment or the status of use of the network.

The second LAN terminal 22 is used as a general LAN-compatible port using Ethernet. The second LAN terminal 22 is connected to equipment, for example, a LAN-compatible HDD port 27, personal computer (PC) 28, and a digital versatile disk (DVD) recorder 29 with a built-in HDD through a hub 26.

Since digital information communicated through the second LAN terminal 22 is control information, the DVD recorder 29 utilizes a dedicated analogue transmission path 30 to transmit analog information of video and audio to the broadcast receiver 11.

The second LAN terminal 22 is connected to, for example, a network 32 such as the Internet via a broadband router 31 connected to the hub 26 and used to communicate information between a PC 33, a cellular phone 34 or the like, and the broadcast receiver 11 via the network 32.

The USB terminal 23 is used as a general USB-compatible port, connected to, for example, a cellular phone 36, a digital camera 37, a card reader/writer 38 for a memory card, an HDD 39, or a keyboard 40. The USB terminal is used to make information transmissions between the equipment and the broadcast receiver 11.

The foregoing i.Link terminal 24 serially connects an AV-HDD 41, a digital (D)-video home system (VHS) 42, etc. and supports information transmissions between the equipment and the broadcast receiver 11.

Here, the AV-HDD 41 connected to the i.Link terminal 24 is shown outside the broadcast receiver 11 in FIG. 1; however, it is actually incorporated in the support base 13. That is, the AV-HDD 41 is integrated with the broadcast receiver 11.

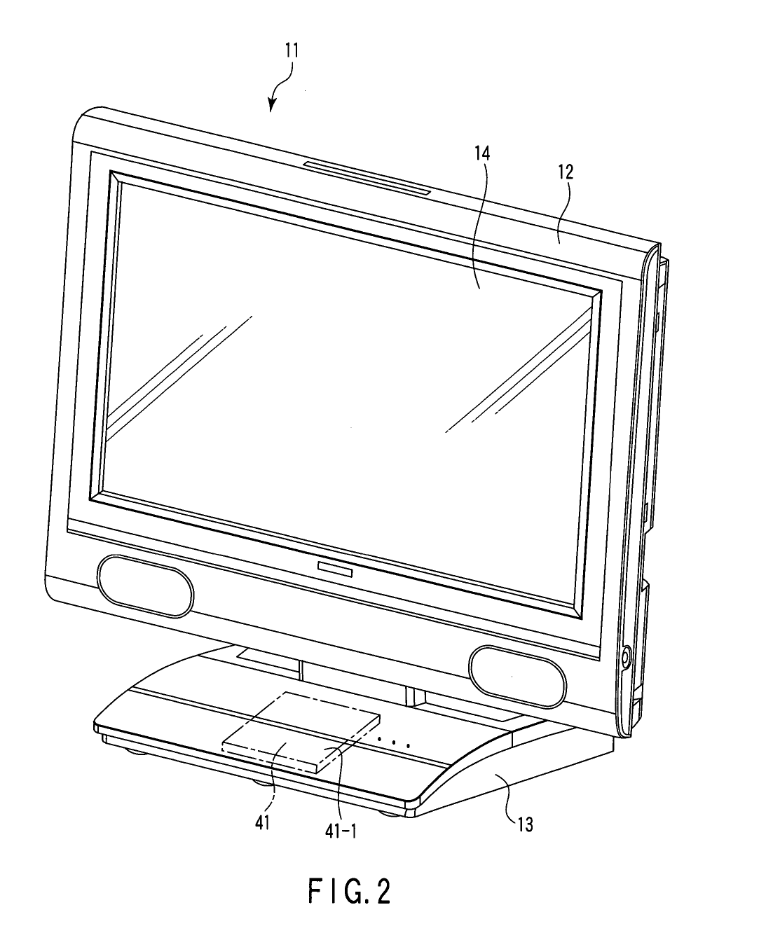

FIG. 2 shows the external view of the foregoing broadcast receiver 11. The AV-HDD 41 (built-in recording equipment) is incorporated in the support base 13.

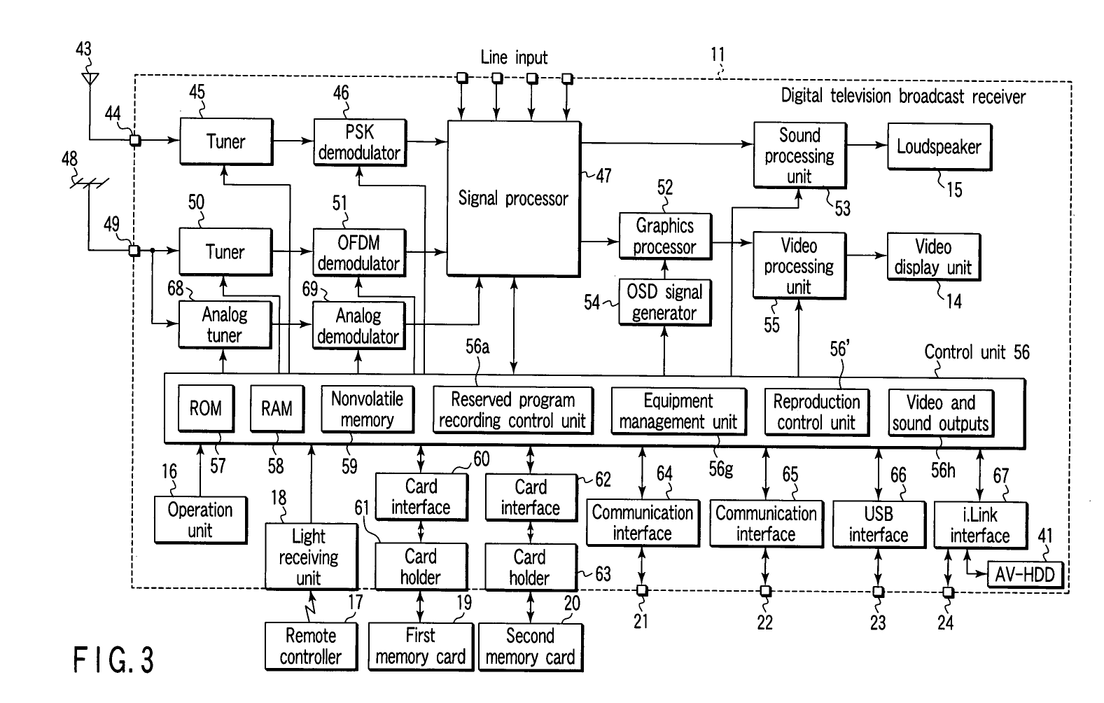

FIG. 3 shows the principle signal processing series of the foregoing broadcast receiver 11. That is, a satellite digital television broadcast signal, received at an antenna 43 for receiving a DBS digital broadcast, is supplied to a tuner 45 for satellite digital broadcast through an input terminal 44, and the tuner 45 tunes a broadcast signal of a desired channel.

The broadcast signal tuned by the tuner 45 is fed to a phase shift keying (PSK) demodulator 46 to be demodulated to a digital video signal and a digital audio signal, which are output to a signal processor 47.

And the broadcast receiver 11 also has an analog tuner 68 for receiving a terrestrial analog signal. An analog demodulator 69 demodulates the signal received by the analog tuner 68 to output it to the signal processor 47.

A terrestrial digital television broadcast signal, received at a second antenna 48 for receiving terrestrial digital broadcast, is supplied to a tuner 50 for the terrestrial digital television broadcast via an input terminal 49. The tuner 50 tunes the broadcast signal of the desired channel.

The broadcast signal tuned by the tuner 50 is supplied to an orthogonal frequency division multiplexing (OFDM) demodulator 51 to be demodulated to a digital video signal and a digital audio signal then output is not expected to be used because of a failure or any inconvenience thereof to the signal processor 47.

The signal processor 47 selectively conducts prescribed digital signal processing of the digital video signals and sound signals supplied from the PSK demodulator 46 and from the OFDM demodulator 51. The signal processor 47 processes the video signals and analog signals supplied from the analog demodulator 69 and further from the line input terminals, and outputs an output signal to a graphics processor 52 and an audio processor 53.

Among the processors, the graphics processor 52 has a function to superimpose an on-screen display (OSD) signal generated from an OSD signal generator 54 on the digital video signal supplied from the signal processor 47 to output the superimposed signal. The graphics processor 52 can selectively output the video signal output from the signal processor 47 and the OSD signal output from the signal generator 54 and also combine to output both outputs so that both outputs configure a half of a screen, respectively.

The digital video signal output from the graphics processor 52 is supplied to a video processor 55. The video processor 55 converts the input digital video signal into an analog video signal in a format possible to be displayed on the video display unit 14 and outputs the analog video signal to the video display unit 14 to produce a video display.

The audio processor 53 converts an analog audio signal in a format that can be reproduced by the loudspeaker 15 and outputs the analog audio signal to the loudspeaker 15 to make an audio reproduction.

As further shown in FIG. 2, the broadcast receiver 11 further comprises a control unit 56. The control unit 56 has a built-in central processing unit (CPU), which receives operation information from the operation unit 16, or receives operation information transmitted from the remote controller 17 and respectively controls each part so as to reflect operation contents thereto.

In this case, the control unit 56 mainly uses a read-only memory (ROM) 57 with a control program to be executed by the CPU stored thereon, a random access memory (RAM) 58 to provide an operation area to the CPU and a nonvolatile memory 59 to which a variety of items of setting information and control information are stored.

The control unit 56 is connected to a card holder 61 to which the first memory card 19 can be attached through a card interface 60. The control unit 56 is adapted to support the exchange of information transmissions with the first memory card 19 attached to the card holder 61 through the card interface 60.

The control unit 56 is further connected to a card holder 63 to which the second memory card 20 can be attached through a card interface 62. The control unit 56 thereby can communicate information with the second memory card 20 attached to the card holder 63 through the card interface 62.

The control unit 56 is also connected to the first LAN terminal 21 through a communication interface 64. The control unit 56 thereby can communicate with the LAN-compatible HDD 25 connected to the first LAN terminal 21 through the communication interface 64. In this case, the control unit 56 has a dynamic host configuration protocol (DHCP) server function and assigns an Internet protocol (IP) address to the LAN-compatible HDD 25 connected to the first LAN terminal 21 to control the HDD 25.

The control unit 56 is further connected to the second LAN terminal 22 through a communication interface 65. The control unit 56 thereby can communicate with any equipment (refer to FIG. 1) connected to the second LAN terminal 22 through the communication interface 65.

The control unit 56 is further connected to the USB terminal 23 through a USB interface 66. The control unit 56 thereby can communicate with any equipment (refer to FIG. 1) connected to the USB terminal 23 through the USB interface 66.

Furthermore, the control unit 56 is connected to the i.Link (registered trademark) terminal 24 through an i.Link (registered trademark) interface 67. Thereby, the control unit 56 can communicate with any equipment (refer to FIG. 1) connected to the i.Link (registered trademark) terminal 24 through the i.Link (registered trademark) interface 67.

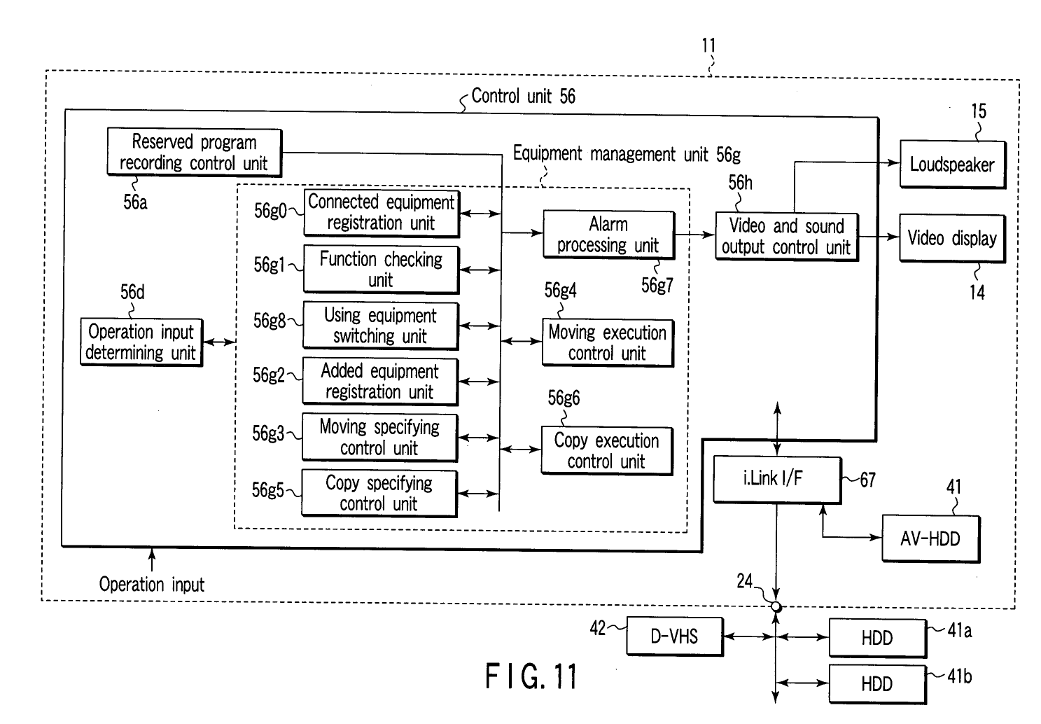

The control unit 56 furthermore includes a reserved program recording control unit 56a, and an equipment management unit 56g. The equipment management unit 56g includes a using equipment switching unit 56g8 (refer to FIG. 11) to switch the control unit 56 so that the external recording equipment (HDD) 41a operates as the internal recording equipment (AV-HDD) 41 when the internal recording equipment is operated. The equipment management unit 56g is configured as a featured part of the broadcast receiver 11. The featured part will be described later.

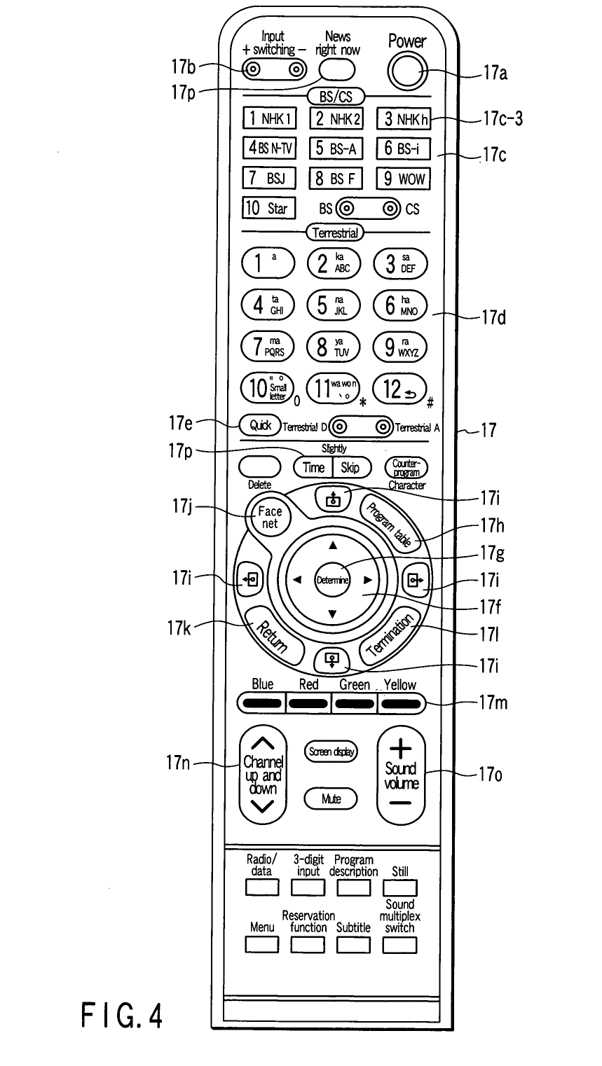

FIG. 4 shows the external view of the remote controller 17. The remote controller 17 mainly comprises a power key 17a, input switching keys 17b, direct tuning keys 17c for satellite digital broadcast channels, direct tuning keys 17d for terrestrial broadcast channels, quick keys 17e, cursor keys 17f, a determination key 17g, a program table key 17h, page switching keys 17i, a face net (registered trademark) (navigation) key 17j, a return key 17k, a terminate key 17l, color keys in blue, red, green and yellow 17m, a channel up and down key 17n, a sound volume adjusting key 17o, etc. Furthermore, the remote controller 17 has a “News right now” key 17p, a “Slightly time” key 17q and a “Slightly skip” key 17r.

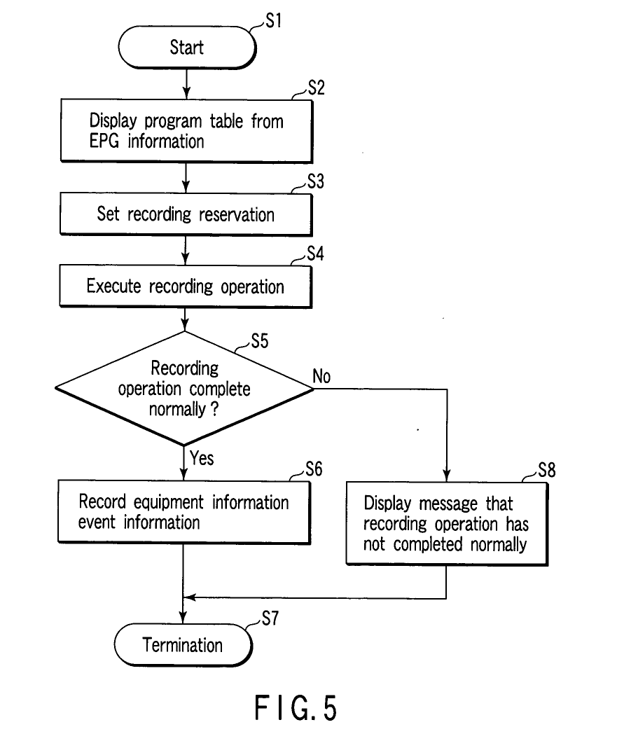

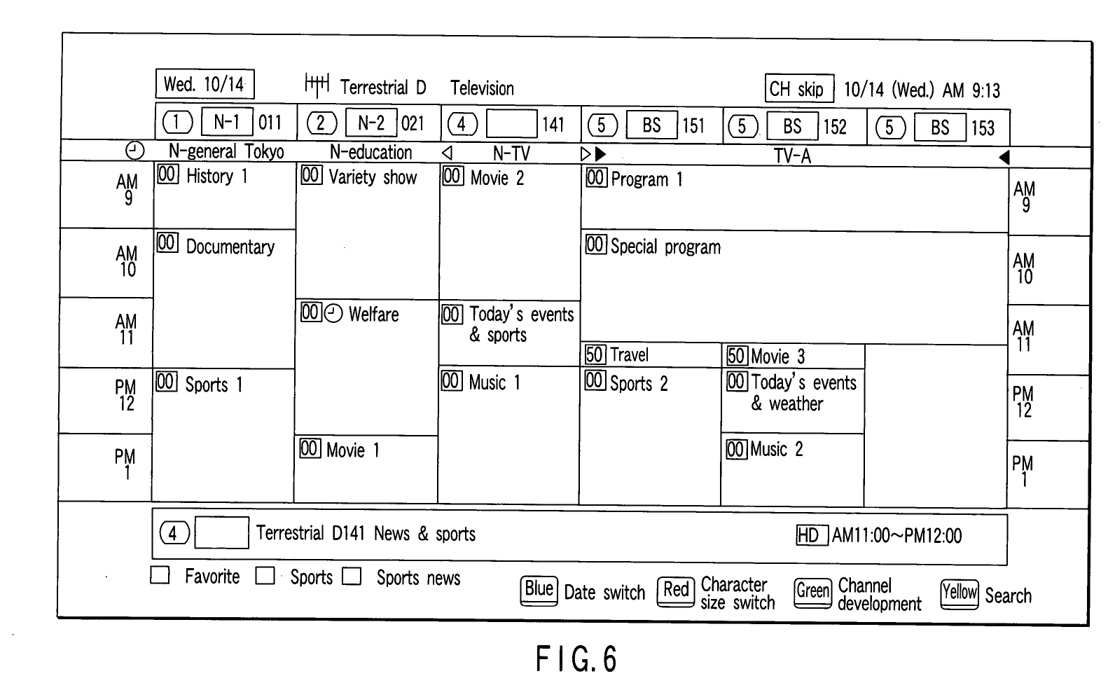

FIG. 5 shows the flowchart for explaining the operations of the broadcast receiver 11 in recording a program into the digital recording equipment with each of the equipment connected to the terminals 21-24 of the broadcast receiver 11. When processing is started resulting form a request of the recording of the program (block S1), the control unit 56 of FIG. 3 displays the program table as shown in FIG. 6 on the video display unit 14 on the basis of electronic program guide (EPG) information acquired from the broadcast signal (block S2).

The user then makes recording reservation setting of the desired programs on the basis of the displayed program table (block S3). In this setting, the broadcast receiver 11 selects the program to be recorded from the program table and also selects to set the digital recording equipment to which the reservation-set program is recorded.

The control unit 56 executes a recording operation so as to record the reservation-set program into the reservation-set digital recording equipment when it has reached the preset time set for the recording reservation (block S4).

The control unit 56 then determines whether or not the program recording operation has normally completed, and if it is determined that the recording operation has completed normally (Yes, in block S5), the broadcast receiver 11 records equipment information (equipment ID, equipment name, shared holder name, etc.) to specify the digital recording equipment which has performed recording. The broadcast receiver 11 further records event information (event ID, channel number, title, content description, category, recording range, image quality mode, etc.) related to the recorded program into the nonvolatile memory 59 (block S6) and terminates this processing (block S7).

If it is determined that the operation has not completed normally (No, in block S5), the control unit 56 of FIG. 3 displays a message indicating the fact that the operation has not completed normally onto the video display unit 14 of FIG. 1 (block S8) and terminates this processing (block S7).

Accordance to the above-mentioned recording operations, the user can arbitrarily select multiple sets of digital recording equipment connected to each terminal 21-24 of the broadcast receiver 11 and record programs sequentially.

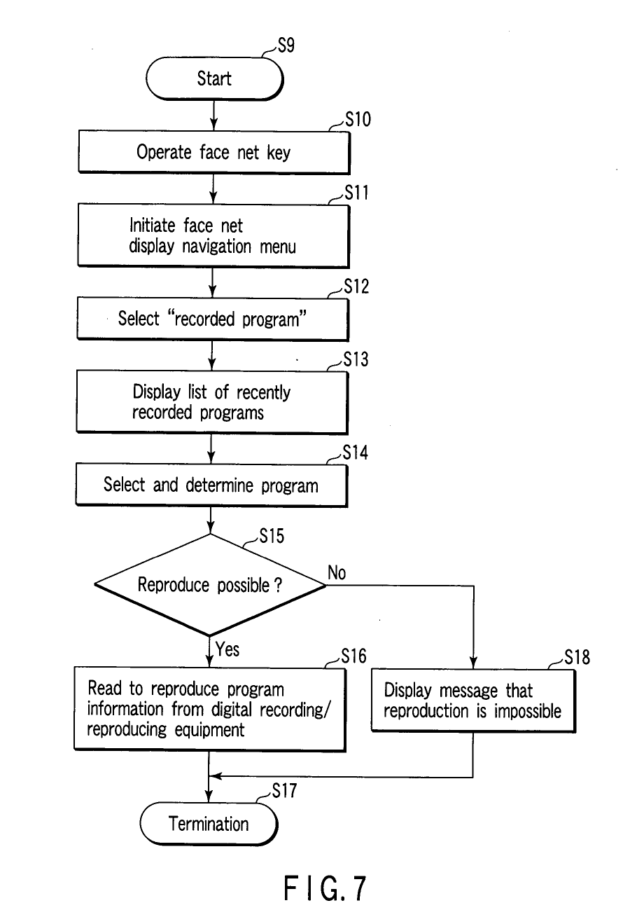

FIG. 7 shows the flowchart for explaining operations to quickly retrieve the desired program and reproduce among a variety of programs recorded in the plurality of sets of the digital recording equipment as mentioned above. When the processing begins (block S9), the user operates the face net (registered trademark) key 17j of the remote controller 17 (block S10). (Note: face net (registered trademark) is a graphical guide screen for the user.)

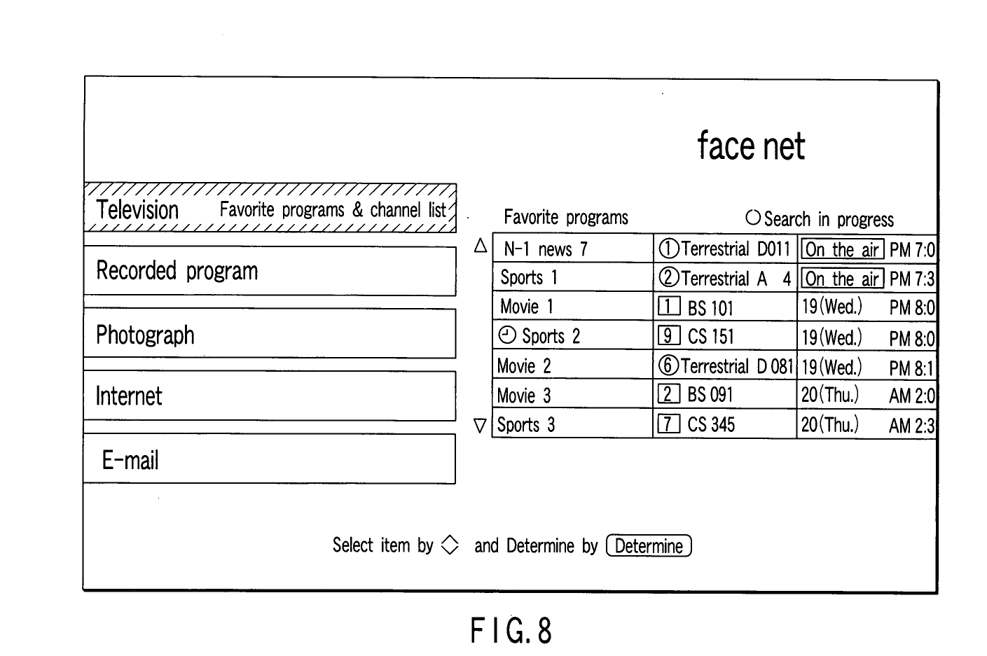

The control unit 56 then starts up the face net (registered trademark) (navigation) and displays the navigation menu as shown in FIG. 8 onto the video display unit 14 (block S11). Five items of “television”, “recording program”, “photograph”, “Internet” and “E-mail” are selectively provided in this menu. The selected items are displayed on a screen in different color from those of other items, and a state in which the “television” item is selected is indicated by hatching in FIG. 8.

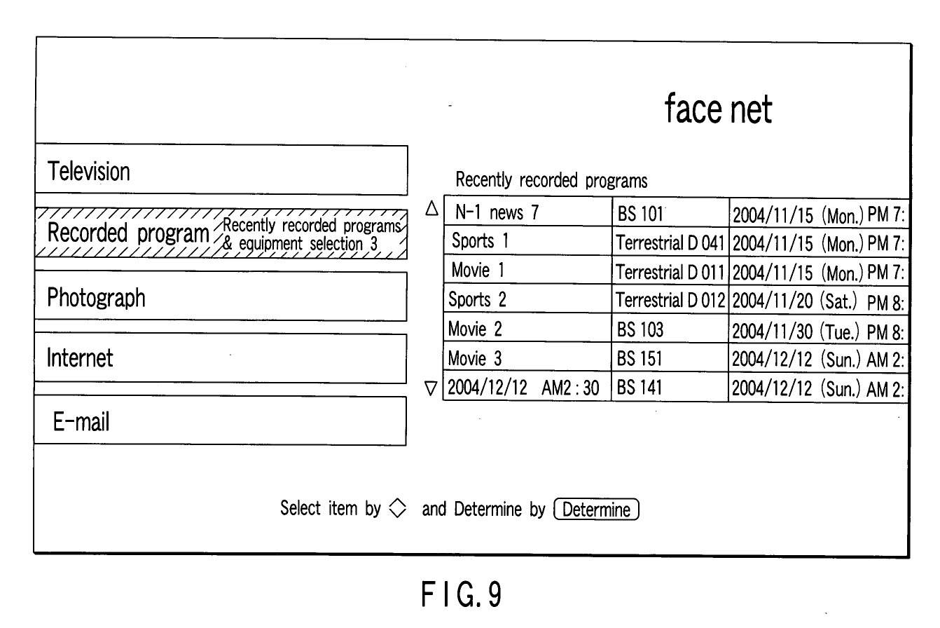

Here, it is assumed that the use operates the cursor key 17f of the remote controller 17 and selects the “recording program” item (block S12). The control unit 56 is brought into a state of selection of the “recording program” item as indicated by hatching in FIG. 9.

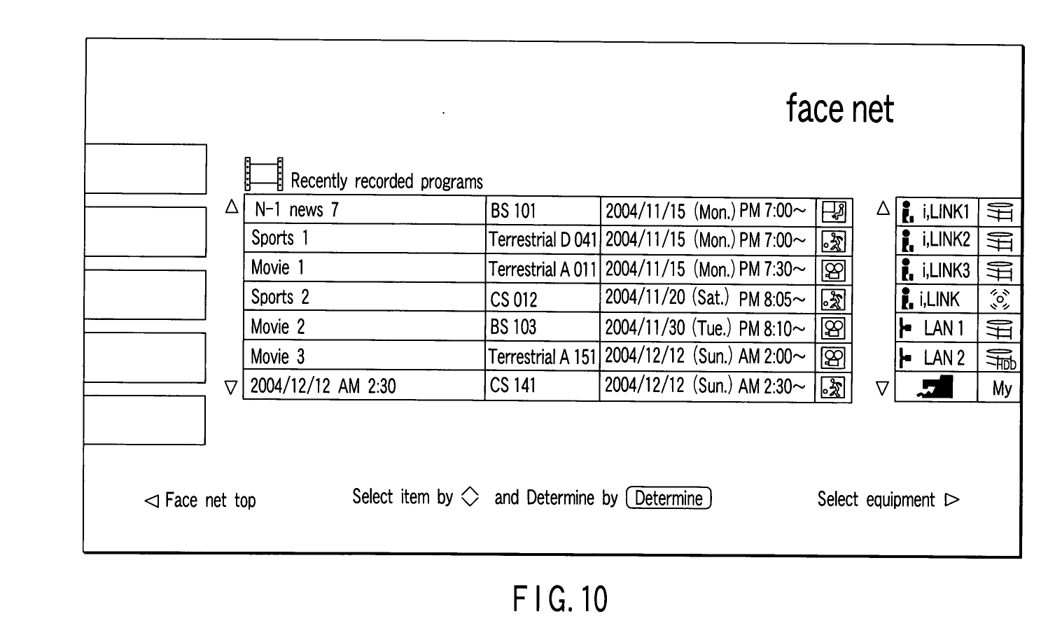

In this state, when the user operates the determine key 17g of the remote controller 17 (block S13), the control unit 56 displays a list of the recently recorded programs onto the video display unit 14 as shown in FIG. 10. In this program list, the titles, broadcast channels, recording dates, days of the week, hours, categories, etc., are displayed as information indicating the recorded programs.

The list of the recently recorded programs is created by referring to equipment information specifying the digital recording equipment that has conducted the recording and the event information in relation to the recorded programs recorded on the nonvolatile memory 59 in reservation recording of the programs explained in FIG. 5. In the list, it is possible to display information indicating thirty-five programs at a maximum as far as from the latest recorded program in relation to the list of recently recorded programs, regardless of the digital recording equipment with the program recorded therein. Having displayed seven programs in a list form in FIG. 10, the user can see the list of thirty-five programs by operating the cursor key 17f to scroll the display. If the user operates the page switching key 17i of the remote controller 17, the user can skip the seven programs displayed in the list at once.

When the user operates the cursor key 17f of the remote controller 17 to select information indicating the desired program from the list of the recently recorded programs and operates the determine key 17g to determine it (block S14), the control unit 56 specifies the digital recording equipment with the selected and determined a program recorded therein from information recorded in the nonvolatile memory 59 and determines whether or not the program can be reproduced (block S15).

Whether the program can be reproduced or not is determined by comprehensively comparing various conditions in recording and in reproducing. For example, this may be conducted by determining one or more of the following: (i) whether or not the broadcast receiver 11 is connected to the digital recording equipment with the reproduction-requested program recorded therein, (ii) whether or not power is turned on to the digital recording equipment with the reproduction-requested program recorded therein, (iii) whether or not the program is still recorded in the targeted digital recording equipment, etc.

Referring still to FIG. 7, if it is determined that the recorded program can be reproduced (Yes, in block S15), the control unit 56 reads out the information about the reproduction-requested program from the targeted digital recording equipment and controls the broadcast receiver 11 to reproduce the program (block S16) then terminates this processing (block S17).

If it is determined that the recorded program cannot be reproduced (No, in block S15), the control unit 56 displays a message indicating the fact that the reproduction-requested program cannot be reproduced onto the video display unit 14 (block S18) and terminates this processing (block S17).

According to the foregoing reproduction operations, since the broadcast receiver 11 has a navigation function to display, in a list, the thirty-five recorded programs at a maximum as far as from the latest recorded program regardless of the digital recording equipment with the desired program recorded therein, the user can easily manage the programs recorded in a plurality of sets of digital recording equipment. Accordingly, it becomes possible for the user to quickly retrieve and reproduce the desired program by locating the desired program using the cursor key 17f and selecting the desired program among programs displayed in a list form through use of the determine key 17g.

Considering the increase in the number of the connected sets of the digital recording equipment and the recorded programs, it becomes impractical to display in a list the whole of the programs recorded in the plurality of sets of the digital recording equipment. As the embodiment stated above, it is a practical setting to hardly cause substantial trouble for the user to display, in a list form, a predetermined number of programs (e.g., thirty-five programs) at a maximum as far back as from the newest recorded program.

FIG. 11 is a view for showing the details of the control unit 56 to explain the characteristics of the broadcast receiver 11.

An equipment management unit 56g includes a using equipment switching unit 56g8 to set and operate the control unit 56 so as to control the external recording equipment (HDD) 41a as internal recording equipment (AV-HDD) 41 in accordance with the operations from the remote controller 17. The switching unit 56g8 is used, for example, to virtually use the HDD 41a as internal recording equipment when the AV-HDD 41 has failed. In this case, the control unit 56 includes, for example, means for displaying a list of connected equipment including the external recording equipment to display the list shown at the right side in FIG. 10. The switching unit 56g8 includes means for registering equipment information and ID, etc., of the HDD 41a, when the external recording equipment is selected among the list in accordance with the operation inputs. After this switching, when the main body of the broadcast receiver 11 is turned on/off, the power for the HDD 41a is controlled to be turned on/off in synchronization with the power on/off of the main body. This power on/off is realized by a command transferred via the i.Link (registered trademark). The user can operate the external recording equipment with the feeling to operate the internal recording equipment as has been done in the past.

Moreover, the equipment management unit 56g has a connected equipment registration unit 56g0 and a function checking unit 56g1 to check the function of the connected equipment. The equipment management unit 56g may further have an added equipment registration unit 56g2. The added equipment registration unit 56g2 is different from the forgoing connected equipment registration unit 56g0 in registration conditions. The connected equipment registration unit 56g0 registers all of the equipment connected to the broadcast receiver 11. On the other hand, the added equipment registration unit 56g2 registers, for example, external recording equipment (HDD 41b) having the same function that of the internal AV-HDD 41. Therefore, the external recording equipment 41a is intentionally checked in its function by means of software initiated by an operation of the user, and when the prescribed condition is satisfied, the ID, etc., of the external recording equipment 41a is registered in the registration unit 56g2.

Furthermore, the equipment management unit 56g has a moving specifying control unit 56g3 to select a content recorded in the first recording equipment and specify the moving to the second recording equipment and a moving execution control unit 56g4 to execute the moving. Moreover, the equipment management unit 56g has a copy specifying control unit 56g5 and a copy execution control unit 56g6 for specifying recording equipment regarding an origin of a copy and a content to be copied and also specifying recording equipment to be a destination of the copy. The equipment management unit 56g also includes an operation input determining unit 56d. The determining unit 56d analyzes the command for the operation inputs and contributes for operation starts of any unit.

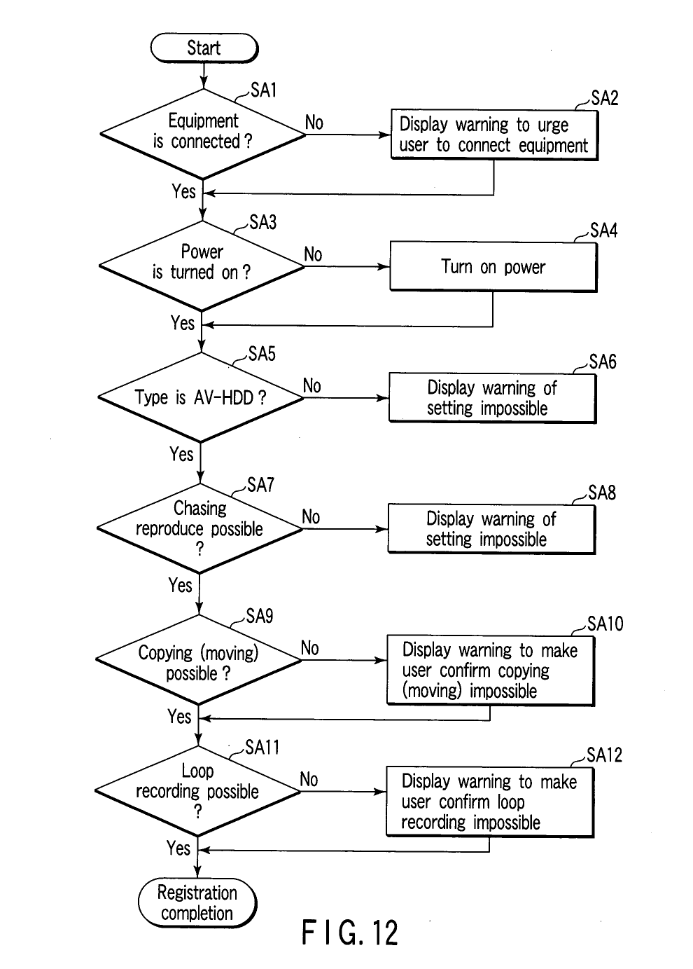

FIG. 12 shows the flowchart of an example of checking operations in the case that, for example, the HDD 41a (virtual HDD) to be the external recording equipment is set to be virtually used as the internal recording equipment (AV-HDD 41). These operations are mainly executed by the checking unit 56g1. Therefore, the checking unit 56g1 also functions as means for setting and registering the external recording equipment.

When registering the external equipment as virtual equipment, the function checking unit 56g1, for example, selects the external equipment from the menu screen. On the menu screen, such an item of “registers external equipment as internal equipment” is appeared. When the user selects this item through the cursor key 17f and presses the determine key 17g, it is started to check the connected equipment and the list of the connected equipment (or a list of the connected equipment under the management by the registering unit 56g0) is displayed on the screen.

When an equipment selection is conducted from the list of the connected equipment, it is checked whether or not any equipment is connected to the receiver 11 and the checking result is displayed on the screen (block SA1). In general, in the case that the power of the previously used equipment has been tuned off, the area of the corresponding equipment among the equipment in the list is displayed in gray sometimes.

When any external equipment is not connected to the broadcast receiver 11, the video display 14 issues a warning to the user to prompt of connection of any equipment (block SA2). When any external equipment is connected to the receiver 1, the equipment management unit 56g checks whether or not the power for the connected equipment is turned on (block SA3), and if the power is turned off, the power is turned on (block SA4). When the power is turned on, the equipment management unit 56g checks whether or not the type of the connected equipment is an AV-HDD, namely, the same type as that of the AV-HDD 41 which is integrated with the broadcast receiver 11 (block SA5). If the connected equipment is not the same type as that of the AV-HDD 41, video display 14 displays the warning of the fact that the connected equipment is impossible to be set and registered (block SA6).

In the foregoing block SA5, when it is determined that the external equipment is the same type as that of the AV-HDD 41, the checking unit 56g1 checks whether or not the type of the external equipment to be set has a chasing reproduction function (block SA7). In this system, since the AV-HDD 41, surely integrated with the broadcast receiver 11, has the chasing reproduction function, it is also needed for the AV-HDD 41a to be set to surely have the chasing reproduction function. If the AV-HDD 41a does not have the function of the chasing reproduction function, the video display 14 display the warning that the external equipment is not allowed being set (block SA8).

The chasing reproduction function is one to sequentially chase the pre-recorded part to reproduce it by a reproduction operation even in the middle of, for example, recording of the reserved program.

When it is determined that the AV-HDD 41a can perform the chasing reproduction in the block SA7, it is checked whether or not the AV-HDD 41a has a function of copying and moving (block SA9). If the AV-HDD 41a does not have a function of copying and moving, the video display 14 displays the warning, indicating that the AV-HDD 41a can not copy and move (block SA10).

When it is determined that the AV-HDD 41a has the function of copying and moving, it is determined whether loop recording is possible or not. The loop recording is a function of cyclically recording under the setting of a fixed recording area. It is also possible to perform the chasing reproduction in this fixed recording area. If the external equipment has not the function of the loop recording function, the video display 14 displays the warning to make the user confirm that the loop recording reproduction is impossible. Otherwise stated, the equipment management unit 56g completes the registration of the external equipment (in this case, AV-HDD 41a). In the foregoing steps, when the user intend to confirm the functions of the equipment to be registered, the system performs authentication processing and confirmation processing between the main body of the television broadcast receiver and the external equipment via the i.Link (registered trademark). Accordingly, it is no wonder for the external recording equipment to have a return function to return equipment information on a status or the like when the return is required.

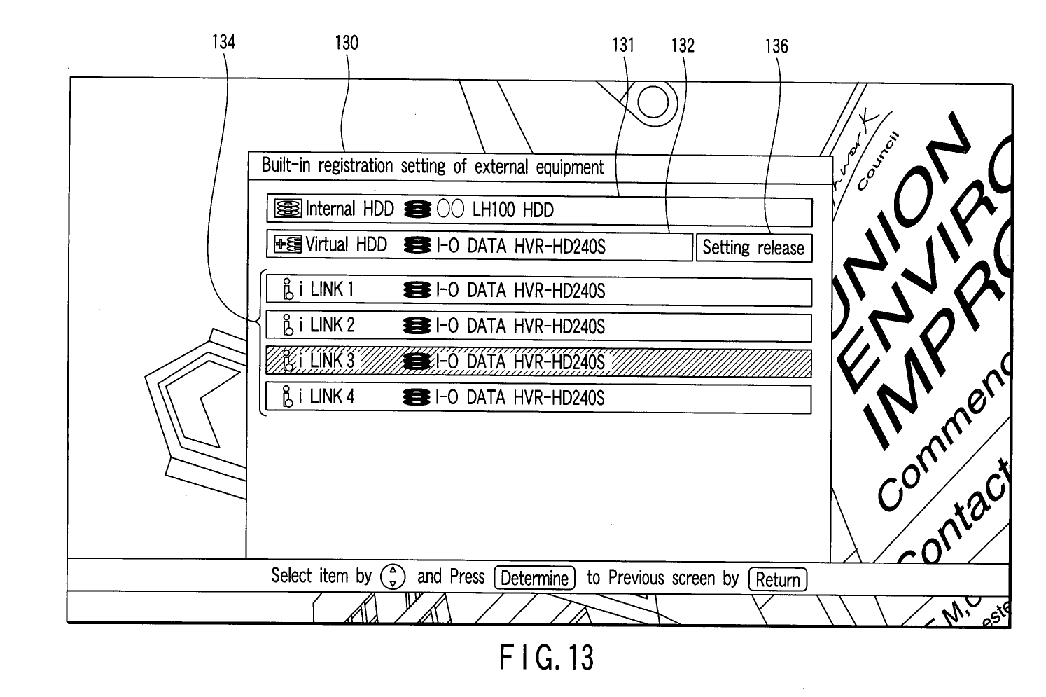

FIG. 13 shows the example of a screen, for example, when the AV-HDD 41a is set as virtual recording equipment to be set and registered. A screen 130 with a title of “setting of external equipment as internal equipment” is appeared and the name 131 of the HDD equipment originally incorporated in the broadcast receiver 11 and the name 132 of the virtually-set HDD equipment are displayed on the screen 130. Furthermore, other equipment 134 connected to an i.Link (registered trademark) terminal 24 is listed and displayed.

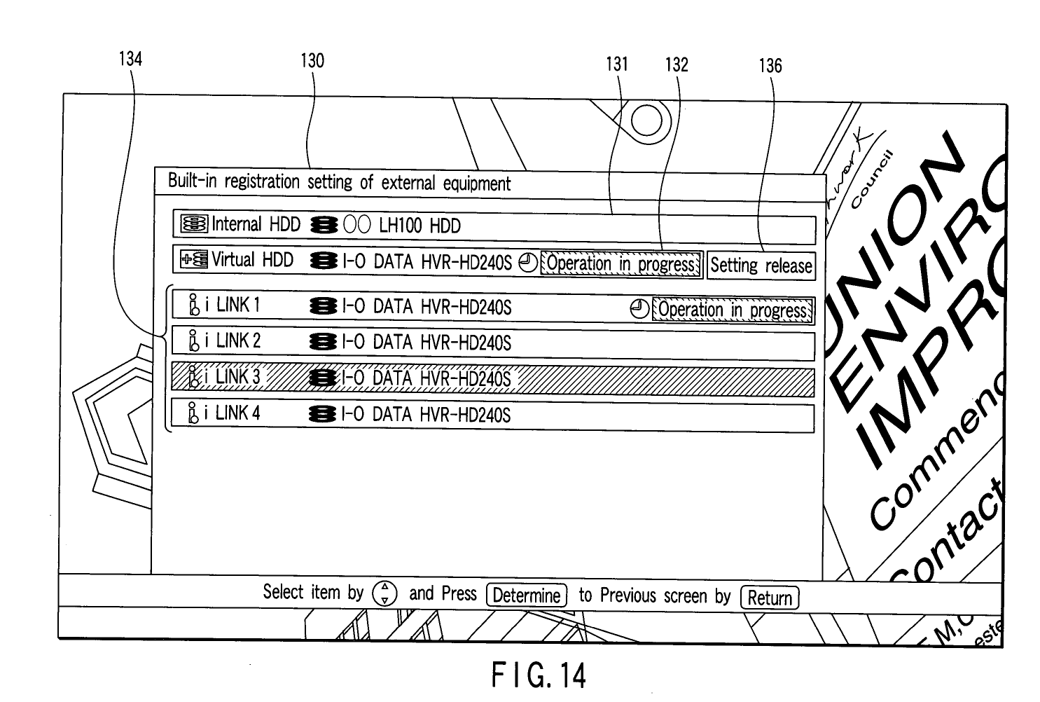

FIG. 14 shows the example of a screen in the case that an external equipment to be set is under operation when the user intends to set and register the external equipment so that the external equipment becomes equivalent to the internal equipment as mentioned above. In this case, a mark 135 indicating that the external equipment to be set is under operation is appeared. Here, the external equipment cannot be set and registered, so that the user can release the setting by putting the “Cursor” at a “setting release” button 136 to operate the key of the “Determine”.

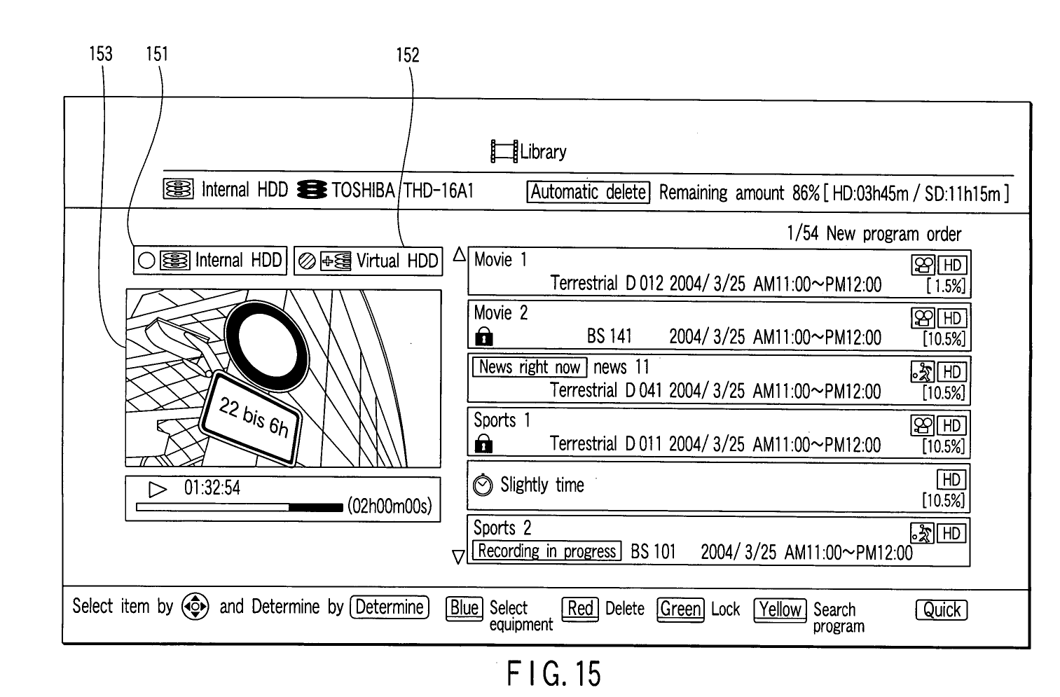

FIG. 15 shows the example of a display of a recording list (right side on screen) on a screen after the external equipment is set as virtual recording equipment. FIG. 15 also shows an aspect that the user pre-views, for example, a recorded program entitled “News right now” at the left side of the screen. In this case, the screen displays the fact that the internal HDD and the virtual HDD are present in partial display areas 151 and 152, respectively. Discrimination marks of the display areas 151 and 152 may be different in color so that it can be recognized that which HDD is now under reproduction of its pre-view video on a pre-view screen 153. Moreover, either mark of the display area 151 or 152 may blink on and off.

In the example of the foregoing screen, areas indicating the presences of the internal HDD and the virtually-set HDD are provided on the screen, and the area indicating the presence of the added HDD may be provided there. The added HDD has a different definition of a usage pattern from that of the virtually-set HDD. The added HDD has an object to expand a storage capacity of the internal HDD or the virtually-set HDD and to be used together with the internal HDD or the virtually-set HDD. However, the virtually-set HDD has a function of being used as a substitution of the internal HDD if the internal HDD has failed or become inoperative. Therefore, the user can register and use the external recording equipment as the virtual HDD when the internal HDD fails and its substitution is required urgently. Therefore, the user can obtain a time margin for replacing the faulty internal HDD with new one.

The present invention is not limited to the specific embodiment just as described above, and in the stage of the implementation, it is obvious that modifications and concrete variations of the present invention are possible without departing from the sprit and the scope of the invention. It is further understood that a variety of inventions can be formed by appropriately combining a plurality of constituent elements disclosed in the foregoing embodiments. For example, some of the constituent elements may be eliminated from the entire constituent elements shown in the embodiments. Furthermore, the constituent elements extending over the different embodiments may be combined appropriately.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A television broadcast receiver, comprising:
a receiving unit which receives a broadcast signal of the broadcast receiver;
a demodulating and signal processing unit which demodulates and signal processes a received signal to convert it into a display signal;
a recording processing unit which records the display signal on a recording medium in response to an operation input;
a control unit which manages operations;
a housing unit for a first recording equipment connected to the broadcast receiver as main recording equipment;
a connection terminal to connect second recording equipment outside the broadcast receiver; and
a using equipment switching unit which switches the control unit so that the second recording equipment is operated in response to an operation instruction after the second recording equipment being specified as a using equipment.

2. The television broadcast receiver according to claim 1, which further comprises
an alarm processing unit which displays a state of the first recording equipment through the display when the first recording equipment fails; and in which
the display output unit displays the list of the equipment connected to the broadcast receiver in response to an alarm display by the alarm processing unit.

3. The television broadcast receiver according to claim 1, which further comprises
a function checking unit which detects whether or not the external recording equipment has the same function as that of the internal recording equipment in response to the operation input, and in which
the using equipment switching unit switches the control unit so that the second recording equipment is controlled in place of the first recording equipment when the checking result of the function checking unit indicates that the function of the second recording equipment is the same as that of the first recording equipment.

4. The television broadcast receiver according to claim 3, wherein
the using equipment switching unit stops operations of the first recording equipment after the using equipment switching unit switches the control unit so that the second recording equipment is controlled as the first recording equipment.

5. The television broadcast receiver according to claim 3, wherein
the using equipment switching unit controls power on/off operations of the second recording equipment in synchronization with power on/off operations of the television broadcast receiver.

6. The television broadcast receiver according to claim 3, wherein
the function checking unit determines that the second recording equipment is a hard disk device, has a chasing reproduction function and has copying and moving functions.

7. A television broadcast receiving method of a broadcast receiver having a control unit which controls operations of first recording equipment, receiving a broadcast signal on the basis of the control of the control unit, demodulating and signal processing the received signal by a demodulating and signal processing unit to convert it to a display signal, and recording the display signal on a recording medium by a recording processing unit, comprising:
checking whether or not external second recording equipment connected to a terminal for connecting external equipment is the same type as that of the first recording equipment;
checking whether or not the second recording equipment has a chasing reproduction function;
checking whether or not the second recording equipment has copying and moving functions;
checking whether or not the second recording equipment has a loop recording function; and
registering the second recording equipment in a registration unit as virtual first recording equipment if the second recording equipment is the same type as that of the first recording equipment, has the chasing reproduction function, has the copying and moving functions and further has the loop recording function.

8. The television broadcast receiving method according to claim 7, further comprising:
displaying a list of connected equipment on a screen; and
displaying a comment indicating that the second recording equipment is under operation on the screen when the second recording equipment is selected as virtual first recording equipment.

9. The television broadcast receiving method according to claim 7, further comprising:
displaying a discrimination display showing that the external second recording equipment has been registered as a virtual first recording equipment; and
displaying a release button to release the registration on a part of a screen.

10. A television system which includes a television receiver having a receiving unit to receive a broadcast signal, a demodulating and signal processing unit to demodulate and signal process the received signal and convert it into a display signal, a recording processing unit to record the display signal on a recording medium in response to an operation input, a connection terminal to connect external equipment, first recording equipment and a control unit to manage operations of the television receiver; and includes external second recording equipment connected to the connection terminal, wherein
the second recording equipment has return means for returning equipment information in response to an authentication request;
the television receiver has means for registering the second recording equipment as a virtual first recording equipment in a registration unit when it is confirmed that the second recording equipment is the same type as that of the first recording equipment, has a chasing reproduction function, has copying and moving functions and has a loop recording function, by analyzing the equipment information.
